(19) United States
(12) Patent Application Publication
(10) Pub. No.: US 2008/0276259 A1
(43) Pub. Date: Nov. 6, 2008

(54) Command Interaction Mapping in a Computing Device

(75) Inventors: Martin Kristell, Twickenham (GB); Matthias Reik, Ronneby (SE)

Correspondence Address: FOX ROTHSCHILD LLP, P O BOX 592, 112 NASSAU STREET, PRINCETON, NJ, 08542-0592, US

(73) Assignee: SYMBIAN SOFTWARE LIMITED, London (UK)

(21) Appl. No.: 11/570,915

(22) PCT Filed: Jul. 1, 2005
(86) PCT No.: PCT/GB2005/002605

§ 371 Date: Dec. 19, 2006

(30) Foreign Application Priority Data
Jul. 2, 2004 (GB) 0414842.5

(51) Int. Cl. G06F 9/44

(52) U.S. Cl. 719/328

(57) ABSTRACT

An intermediate software layer, which is preferably provided by a device manufacturer, processes a list of commands and actions provided by a generic application, and assigns them to various input mechanisms, and constructs appropriate menus to display on the screen of the device. Where the application supports multiple windows, views or panes the intermediate layer is able to distinguish which part of the application has the focus and adjust the actions resulting from user inputs accordingly. Hence, the computing device is operated in such a way that a generic application, not specifically designed for the device, is able to take advantage of those unique input methods that the particular device possesses. A preferred implementation is on devices such as mobile telephones, which have no fixed paradigm for providing input and whose keyboards (where they exist) have no fixed number of input buttons.

This invention relates to a method for operating a computing device and in particular to a method which enables a computing device to run generic software which makes use of input mechanisms and contains menus and user dialogs which are specific to that device.

The term computing device as used herein is to be expansively construed to cover any form of electrical computing device and includes, data recording devices, computers of any type or form, including hand held and personal computers, and communication devices of any form factor, including mobile phones, smart phones, communicators which combine communications, image recording and/or playback, and computing functionality within a single device, and other forms of wireless and wired information devices.

Many computing devices include input mechanisms by which a user can interact with the software controlling the device, either to give command or to input data.

The most traditional of these input devices is the keyboard, which can be characterized by its attribute of having specific keys which are permanently mapped to specific items of data. Keyboards have for many years been extended by the addition of either programmable or dedicated function keys which enable otherwise complex commands or sequences of characters to be executed with a single keypress.

A new form of input via pointing devices rather than keys, popularised by the invention of the mouse in the late 1960s, uses areas of the screen known as controls, which display icons, dialogs or menus with one or more parts that can be clicked on through the use of an on-screen cursor in order to issue commands to the device. This type of screen-based user input can also be used with other types of pointing device in addition to the mouse, such as touch-screens, light pens and joysticks.

User interface software for any computing device includes menus, icons and dialogs that display properly on the screen. In particular, different models of small hand-held devices (such as mobile phones) require different menu structures, text prompts and menus. Usually, these are tailored to the input methods available and to the characteristic of the display; when input is required, the menus need to be appropriate for what is available to a user. A user without a mouse should not be presented with a dialogue requiring a click, and when key presses are required, a user must not be asked to press a key that is not available on that particular device.

There is now a considerable diversity of devices and how to cope with this diversity is something that presents a clear problem for user interface (UI) designers, who have no way of knowing in advance what the parameters of a device might be.

There are a number of possible options which may be used to address this problem:
Design for the prevailing industry standards
Design the UI for a specific device
Provide separate versions of the software for different device families.
Include multiple variation in the user interface and defer the selection of which to use until run-time, when the hardware on the device can be recognised
Design to the lowest common denominator
Design for a standard intermediate software layer such as a virtual machine.

However, none of the above solutions is ideal, either for software users, software producers, or users in general, principally for the following reasons.
Designing for the prevailing industry standards discriminates against devices that incorporate technology with new and innovative features, and because software is not designed to run on these devices, their economic viability is reduced and progress is held back.
Designing the UI for a specific device limits the available market for a product, and frustrates those users.
Providing separate versions of the software for different device families is inefficient for producers, who need to produce multiple versions of the same product. It can also be confusing for users, who may end up with the wrong version.
Including multiple UIs and deciding which one to use at run-time is also highly inefficient; producers need to write UIs that are not going to be used and include them in the software. On computing devices such as mobile phones, this also uses up the scarce memory resources.
Designing for the lowest common denominator makes it impossible for users to have the best possible interface.
Designing for a virtual machine (VM) enables hardware differences to be abstracted away. A virtual machine provides a different intermediate software layer for each device; but every virtual machine provides the same application programming interface (API) for the software which uses it.

The difficulties identified here are not particularly significant for desktop PCs at the moment because input methods and screens are standardised and have not changed much for approximately fifteen years. But, this is not the case for all computing devices.

In particular, the input characteristics of computing devices in the form of mobile communication devices such as cellular telephones differ from manufacturer to manufacturer, and from model to model from the same manufacturer. A few devices, such as the Blackberry from Research in Motion Ltd, have alphanumeric keypads; some have no keypad at all, but simply a touch screen (such as the Nokia 7700 or the Sony Ericsson P800 and P900 when operated with flip open). Most mobile phones have a numeric keypad as standard, but even then there are a number of extra keys or buttons in addition to the keypad which differ from manufacturer to manufacturer, and the convenience of their placement, is highly variable. There are mobile phones with touchscreens and phones without. Some phones have jog-wheels, some have joysticks, which can be either four-way or eight-way; phones can have both jog-wheels and joysticks. Moreover, designing an optimal screen for control of a black and white screen display means that this probably will not be optimal for a colour screen display. The screen size and resolution, and the pixel size, also differ widely between devices. All these factors affect the way the user interface should be designed.

The most relevant known proposal for addressing this problem is the virtual machine implemented by the Sun Microsystems Inc. Java MIDP (Mobile Information Device Profile) menu system. It is noteworthy that the problem described above is specifically addressed in documents such as http://iava.sun.com/j2me/docs/alt-html/midp-stvle-quide7/midp-char.html which states:
“Consider, for example, an address book on a mobile phone with a 100w×128h, four level gray-scale display and an ITU-T phone keypad. The application could have a vertical layout with two soft buttons on the bottom of the screen. Now, move the address book to a device that has a 240w×100h, 256 color display, a stylus, and touch screen. If the application were responsible for the details of the UI, the vertical layout would be awkward and inappropriate.”

The Java MIDP menu system attempts to solve the problem with its high-level LCDUI (Liquid Crystal Display User Interface) API. This absolves applications from providing their own screen controls, and is also able to map some application commands to device-specific keys. However, the Java virtual machine is essentially an abstraction of an ideal or generic hardware environment and all applications must fit with this virtual machine. For example, the machine only supports a simple menu system with a single pane, which is an inflexible restriction that makes it virtually impossible to create flexible applications with views, dialogs and pop-ups, which need multiple panes.

Such virtual machines are in some respects similar to the solution of providing separate versions of the software for different device families, but without any of the disadvantages, as the burden of providing a separate version for each device is shifted from the software provider to the provider of the virtual machine and is only ever taken once. However, they have the same disadvantage as the solution of designing to the lowest common denominator; the characteristics of the virtual machine become another lowest common denominator because hardware differences are abstracted away, it is not possible for unique hardware features to be used to any advantage.

Thus, there has to date been no satisfactory method of building devices so as to enable a generic software application to provide the best user experience for each device on which it runs.

Therefore, it is an object of the present invention to provide an improved way of adapting generic software in order to maximise the facilities available on a multiplicity of device families.

According to a first aspect of the present invention there is provided a method of operating a computing device including one or more generic applications which have not been specifically written for the device, the user interface for the said one or more generic applications supports one or more views, panes or windows requiring separate input; and the one or more generic applications have no knowledge of the input methods available on the device which they should use for accepting commands; the method comprising including a software entity which does have knowledge of the input methods of the device; and the said software entity provides an application program interface (API) for the said one or more generic applications which enables them to utilise input methods of which they have no knowledge.

According to a second aspect of the present invention there is provided a computing device arranged to operate in accordance with the method of the first aspect

According to a third aspect of the present invention there is provided computer software for causing a computing device to operate in accordance with the method of the first aspect.

An embodiment of the present invention will now be described, by way of further example only, with reference to the accompanying drawings in which:—

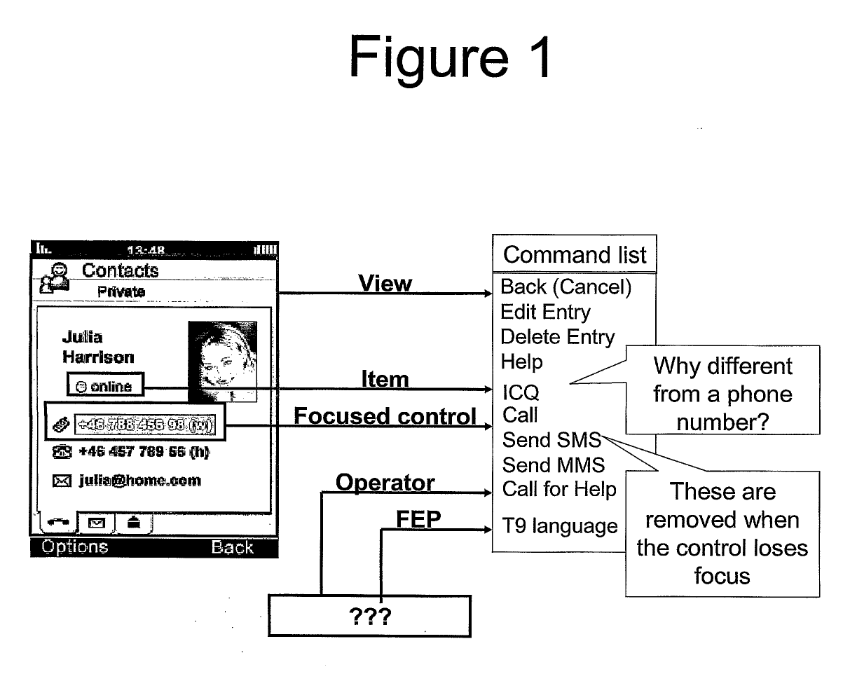

FIG. 1 shows the relationships between screen controls and an application command list for a computing device in the form of a mobile telephone;

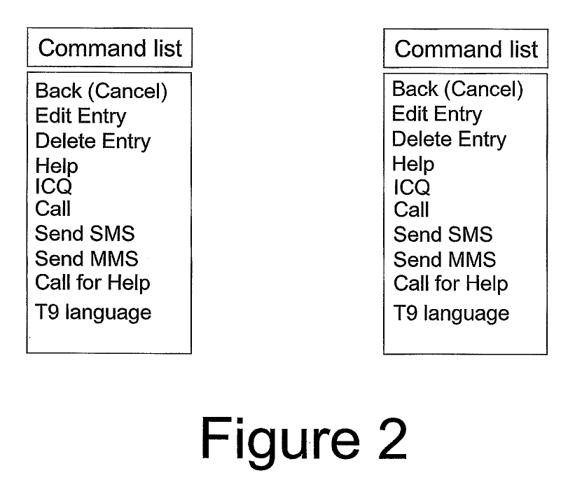

FIG. 2 shows an example of an application command list;

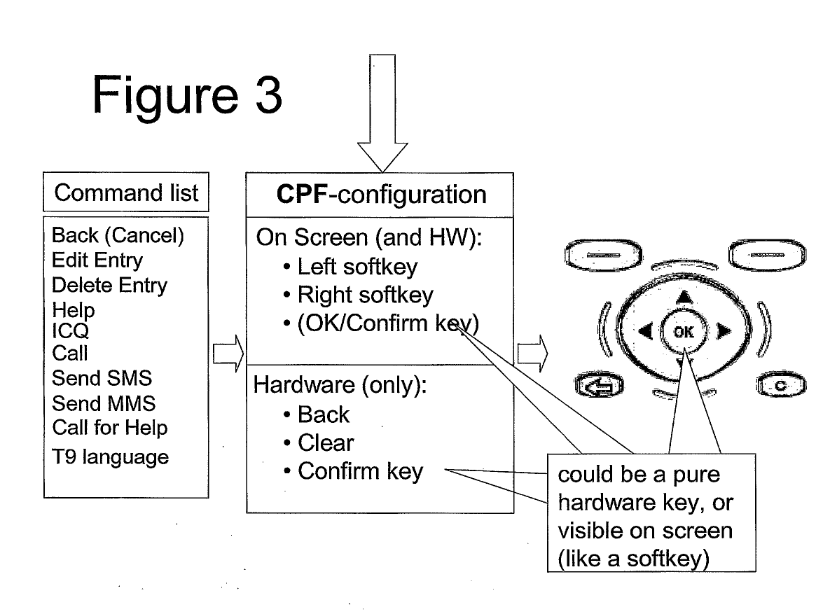

FIG. 3 shows how a command processing framework (CPF) may be used to map application commands to available input methods on a device having two soft keys and a back key;

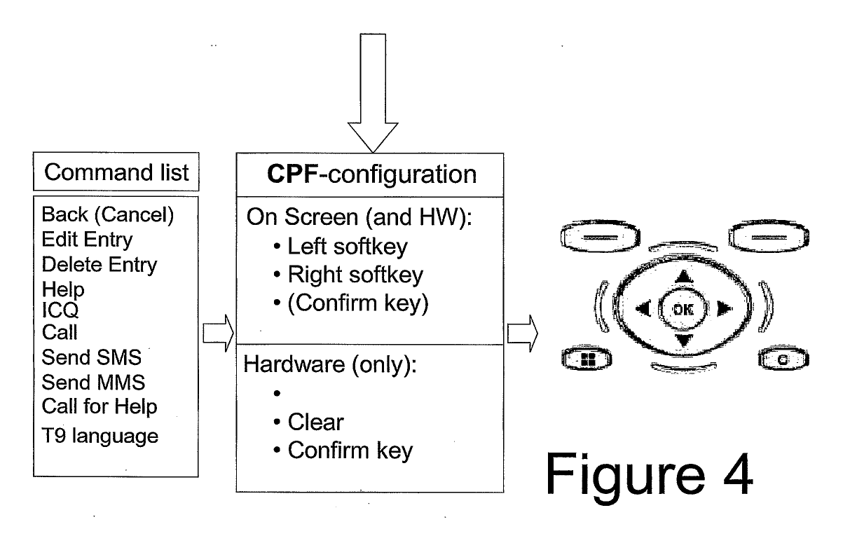

FIG. 4 shows how a CPF maps application commands to available input methods on a device having two soft keys and no back key;

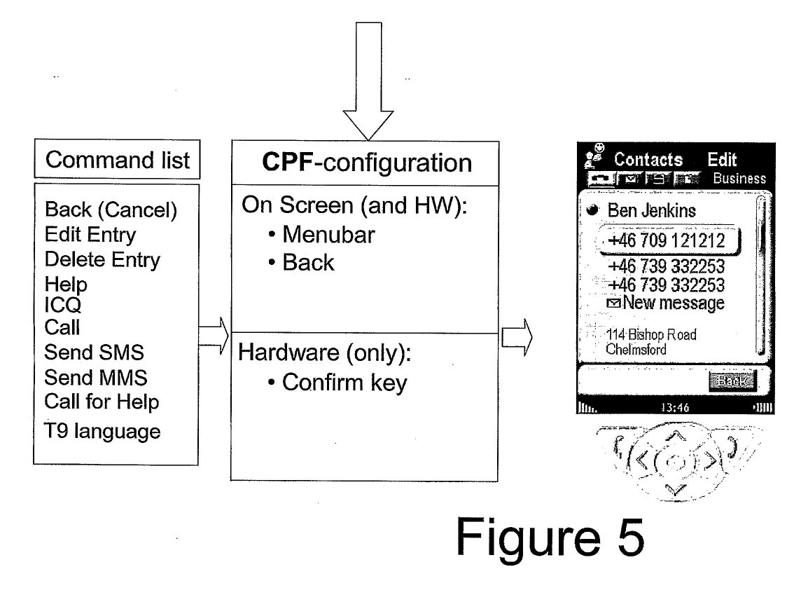

FIG. 5 shows how a CPF maps application commands to available input methods on a device having a touch screen based input mechanism;

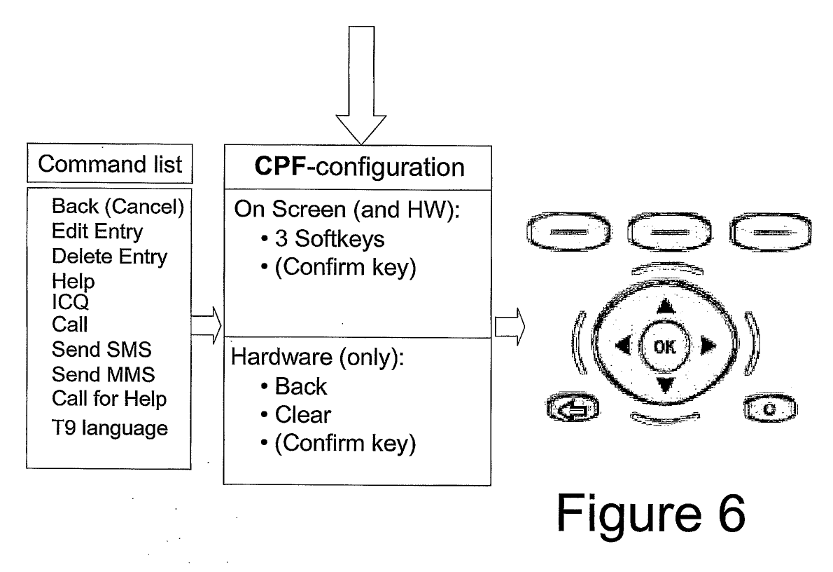

FIG. 6 shows how a CPF maps application commands to available input methods on a device having three soft keys and a back key;

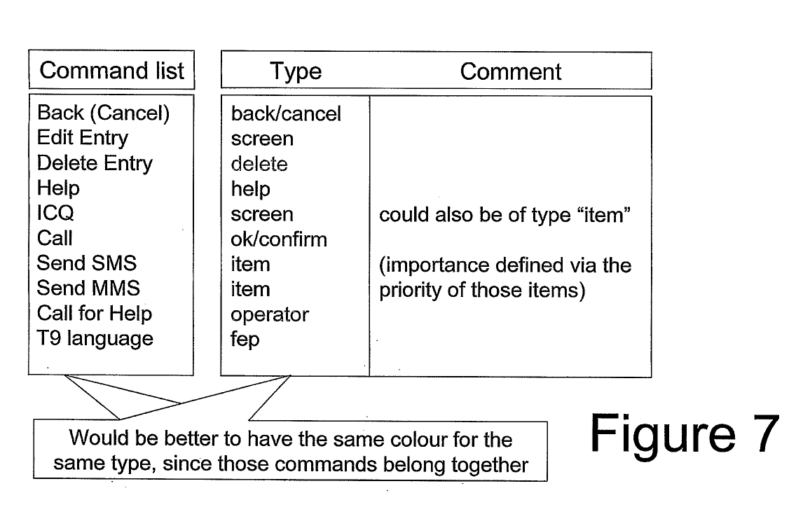

FIG. 7 shows how application commands may be assigned to keys and controls on a device; and

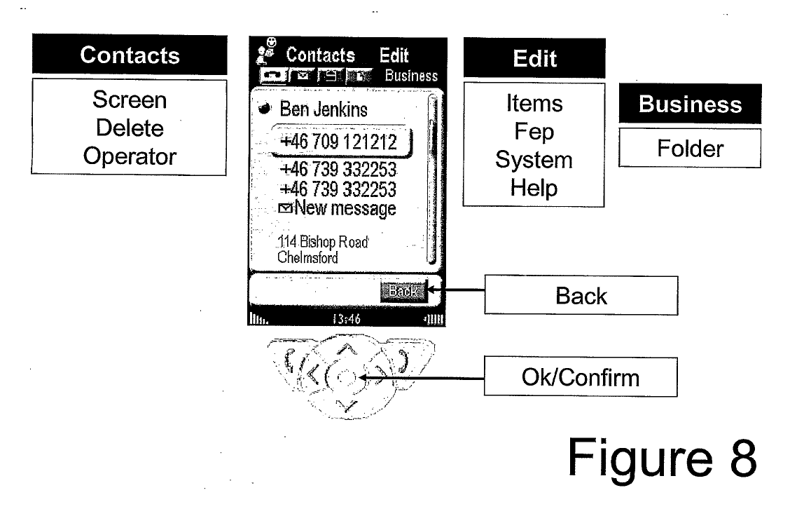

FIG. 8 shows how an application command type may be used to identify where a command should be directed in a device having a touch screen based input mechanism.

In essence, the present invention provides a solution to the problem outlined above by enabling the distribution of application commands to input facilities (such as menu-bar/menu-pane/software or hardware buttons) to be abstracted from an application and handed over to a software entity which is provided by the hardware manufacturer and bound to the device. In the context of the present invention this software entity is referred to as a Command Processing Framework (CPF).

The key difference in the way that a CPF handles input and the way a virtual machine (VM) handles input is that a VM is designed to conceal hardware differences, while a CPF is designed to enable use of them. Thus, the methodologies of the two mechanisms are very different and in strict contrast to each other.

The function of the CPF is described below as it is implemented in the UIQ™ user interface platform from UIQ Technology AB, which is designed to run on the Symbian OS™ operating system, the advanced mobile phone operating system from Symbian Software Ltd. Those skilled in the art of Symbian OS programming using the UIQ interface platform will readily understand this short description; a full tutorial on the programming metaphors used in this operating system are readily available in standard textbooks such as “Symbian OS C++ for Mobile Phones” by Richard Harrison (ISBN 0470856114). Therefore, these metaphors will not be described specifically in this specification. The Command Processing framework is implemented by means of a singleton CPF Manager class (cQcpfManager), which manages all commands in a single application. This is instantiated at application startup. The header file containing the class definition is shown in the specific code examples set out below.

Any CCoeControl that wants its own set of commands must call InitializeResourcesForL. UIQ programs utilising the standard CQikViewBase may achieve this in its ConstructL. When a CommandModelList has been created, the CCoeControl or any of its component controls can add commands to the CPF Manager.

It should be noted that a component control that does not want the parent control's commands to be available when it has focus (i.e. it is the currently active control to which all input is routed) should be on the application user interface control stack and should, therefore, create its own CommandModelList.

CPF Managers do not own any controls, but are able to adopt the standard ones, such as softkey controls, and menu controls. Any CCoeControl that wishes to do so can implement the Mcpfcontrolowner interface and supply a pointer where the CPF Manager can retrieve any additional CPF controls it wants to use.

With the CPF, the application developer describes the commands in the resource file of an application in the standard way as would apply for all system programs. However, in the application's views ConstructL, the view is set up such that the resource definition is handed over to the interface of the CPF Manager. Thus this is the only interface that the application developer needs to interface with, which provides the added benefit that makes it possible for a device manufacturer to replace interaction controls without being worried about binary compatibility.

When a manufacturer creates a device the controls for user interaction, such as softkey controls and menu controls, are defined and configured. When the CPF Manager detects a focus change, the top focused control (which may be a view) is determined, and the corresponding list of commands is retrieved and handed over to the currently active CPF control (which may be a softkey control or a menu bar control). Because there may be more than one control active at a time, controls are prioritised according to an order protocol as determined by the CPF manager. A typical protocol may, for example, determine that high priority controls are given the opportunity to consume commands before these are offered to lower priority controls.

Hence, with the present invention, application developers do not need to worry about the input methods available; for example, whether their application is running on a device with programmable function keys or a touch-screen. Furthermore, device manufacturers or network operators can control the look and feel of any applications that may be loaded on the device, provided that those applications use the CPF.

From the viewpoint of an application developer, the workings of the CPF as are shown in the attached figures. FIG. 1 shows the relationships between screen controls and a command list for an application on a device. Each screen control contributes one or more entries to the command list. In this example the view control contributes four items to the command list, so that the user may cancel the screen being displayed, edit the entry being displayed, delete the entry being displayed, or select a help command for assistance. In the example shown, the command is focused on the phone number of the entry, and three options are available to the user, as indicated. When one of these options is selected, that particular command loses focus, and the entries in the command list for the phone number are deleted form the list. The command list itself is shown in FIG. 2.

FIGS. 3-6 show how the CPF maps commands to available methods on devices with different input methods.

FIG. 7 shows how commands may be categorized by type for assignment to keys and controls.

FIG. 8 shows how the command type may be used to identify the destination of a command in a device having an input method as shown in FIG. 5

In summary, the invention makes it possible to develop tailored applications without knowing the input characteristics of the device on which the application will run by providing a method of controlling a computing device in such a way that a generic application, not specifically designed for that device, is nevertheless able to take advantage of those unique input methods that the particular device possesses. The preferred implementation of this invention is on devices such as mobile telephones, which have no fixed paradigm for providing input and whose keyboards (where they exist) have no fixed number of input buttons. In this invention, an intermediate software layer, which is preferably provided by the device manufacturer, processes a list of commands and actions provided by the designer of a generic application, assigns them to various input mechanisms, and constructs appropriate menus to display on the screen. Where the application supports multiple windows, views or panes the intermediate layer is able to distinguish which part of the application has the focus and adjust the actions resulting from user inputs accordingly.

An example of code for carrying out the invention using the UIQ™ user interface and the Symbian OS™ operating system may be as follows.

// QCpfManager.h
//
// Copyright (c) Symbian Software Ltd 2004. All rights reserved.
// Created for UIQ 3.0
#ifndef _{——}QCPFMANAGER_H_{——}
#define __QCPFMANAGER_H__{—}
#include <e32base.h>
#include <coemain.h>
class CQikAppUi;
class CEikonEnv;
class CCoeControl;
class CQCpfCommand;
class MQCpfControl;
class MQCpfControlOwner;
class CQCpfCommandList;
class MQCpfCommandListOwner;
class CQCpfCommandModel;
/**
@publishedAll
@prototype
The facade class of the Command Processing Framework.
*/
class CQCpfManager : public CCoeStatic, public MCoeFocusObserver

{
public:

/**

* Reasons for panic in CpfCtl
*/

enum TCpfPanic

{
ECpfIllegalControlPriority = 1,
ECpfCommandModelNotFound,
ECpfInvalidCommandType,
ECpfNoDefaultCommandList
};

public:

IMPORT_C static CQCpfManager* StaticL

(CQikAppUi& aAppUi, CEikonEnv& aEnv);

IMPORT_C static CQCpfManager* Static( );
IMPORT_C ~CQCpfManager( );
// Methods for initialize and cleanup
IMPORT_C void InitializeResourcesForL

(CCoeControl& aStackedControl);

IMPORT_C void InitializeResourcesForL

(CCoeControl& aStackedControl, MQCpfControlOwner*

aCustomCpfControlOwner);
IMPORT_C TInt ResetAndDestroyResourcesFor

(CCoeControl& aStackedControl);

// Methods that work on all screenmodes
IMPORT_C void AddCommandModelListL

(CCoeControl& aCpfUser, MQCpfCommandListOwner& aOwner,

TInt aCpfCmdMd1ListResourceId);

IMPORT_C void SetDimmed

(CCoeControl& aCpfUser, TInt aCommandId, TBool aBool);

IMPORT_C void SetChecked

(CCoeControl& aCpfUser, TInt aCommandId, TBool aBool);

IMPORT_C void SetRadioed

(CCoeControl& aCpfUser, TInt aCommandId, TBool aBool);

IMPORT_C void SetInvisible

(CCoeControl& aCpfUser, TInt aCommandId, TBool aBool);

// Methods that operates on one specific screenmode
IMPORT_C void AddCommandListL

(CCoeControl& aCpfUser, MQCpfCommandListOwner& aOwner,

TInt aResourceId, TInt aScreenMode=0);

IMPORT_C void DeleteCommandList

(CCoeControl& aCpfUser, TInt aResourceId, TInt aScreenMode=0);

IMPORT_C void AddCommandL

(CCoeControl& aCpfUser, CQCpfCommand* aCommand,

TInt aScreenMode=0);

IMPORT_C TInt DeleteCommand

(CCoeControl& aCpfUser, TInt aCommandId, TInt aScreenMode=0);

IMPORT_C void InvalidateL( );
IMPORT_C CQCpfCommand* Command

(CCoeControl& aCpfUser, TInt aCommandId, TInt aScreenMode=0);

// Methods primarily intended for dynamic reordering of
// menuitems for a specific screenmode
IMPORT_C CQCpfCommand* Remove

(CCoeControl& aCpfUser, TInt aCommandId, TInt aScreenMode=0);

IMPORT_C TInt InsertCommandBefore

(CCoeControl& aCpfUser, TInt aCommandId,

CQCpfCommand* aCommand, TInt aScreenMode=0);

IMPORT_C TInt InsertCommandAfter

(CCoeControl& aCpfUser, TInt aCommandId,

CQCpfCommand* aCommand, TInt aScreenMode=0);

IMPORT_C void SortCommands

(CCoeControl& aCpfUser, TInt aScreenMode=0);

// Internal methods
RPointerArray<MQCpfControl>& StandardCpfControls( );
static TInt CompareCpfControls

(const MQCpf Control& aCtr1, const MQCpf Control& aCtrl2);

void SetTypeSortOrder(CQCpfCommand& aCmd);
CQikAppUi& AppUi( );

private:

CQCpfManager( );
CQCpfManager(CQikAppUi& aAppUi, CEikonEnv& aEnv);
void ConstructL( );
const TInt Index(CCoeControl& aCpfUser) /*const*/;
CQCpfCommandModel* LookupCommandModelL(CCoeControl& aCpfUser);
void DoInvalidate( );
void SetupFromResourceL( );
void RegisterStandardCpfControlsL( );

| | |
|---|---|
| private: | // from MCoeFocusObserver |

void HandleChangeInFocus( );
void HandleDestructionOfFocusedItem( );

private:

/**
The array of CommandModels used by the application.
Sorted on the address of the owner/user to enable fast check
if a CCoeControl has a CommandModel or not.
*/
RPointerArray<CQCpfCommandModels> iCommandModels;
/**
Store a pointer the currently top focused control
(on appui's control stack). Change of top focused
control usually indicate that another CommandModel
shall become the active CommandModel.
*/
CCoeControl* iCurrentlyTopFocusedControl;
/**
A reference to the control environment supplied at
construction.
To avoid use of the slower CEikonEvn::Static( ) retrieval.
*/
CEikonEnv& iEnv;
/**
A reference to the AppUi supplied at construction.
To avoid use of the slower CEikonEvn::Static( ) retrieval.
*/
CQikAppUi& iAppUi;
class CInvalidateEvent;
friend class CInvalidateEvent;
CInvalidateEvent* iOutstandingInvalidate;
RArray<TInt> iCmdTypeSortOrder;
/**
Array of the standard cpfcontrols like menucontrol and
softkeys.
*/
RPointerArray<MQCpfControl> iStandardCpfControls;

};

#endif // _{——}QCPFMANAGER_H_{——}

Although the present invention has been described with reference to particular embodiments, it will be appreciated that modifications may be effected whilst remaining within the scope of the present invention as defined by the appended claims.

1. A method of operating a computing device including one or more generic applications which have not been specifically written for the device, the user interface for the said one or more generic applications supports one or more views, panes or windows requiring separate input; and the one or more generic applications have no knowledge of the input methods available on the device which they should use for accepting commands; the method comprising including a software entity which does have knowledge of the input methods of the device; and the said software entity provides an application program interface (API) for the said one or more generic applications which enables them to utilise input methods of which they have no knowledge.

2. A method according to claim 1 wherein the software entity is a singleton class which manages all the commands for a single application and which includes predefined softkey or menu controls for user interaction.

3. A method according to claim 1 wherein the one or more generic applications provide a list of commands that need mapping to the software entity.

4. A method according to claim 1 wherein the one or more generic applications include controls which provide a list of commands that need mapping to the software entity.

5. A method according to claim 4 wherein the software entity is enabled to detect which applications or controls have focus and is enabled to adjust the list of commands it should be using to that provided by the application or control that has focus.

6. A method according to claim 4 wherein controls are prioritised by the software entity.

7. A computing device arranged to operate in accordance with a method as claimed in claim 1.

8. Computer software for causing a computing device to operate in accordance with a method as claimed in claim 1.
